(19) United States
(12) Patent Application Publication
(10) Pub. No.: US 2022/0247323 A1
(43) Pub. Date: Aug. 4, 2022

(54) RECTIFIER FOR MILLIMETER-WAVE AC VOLTAGE SIGNALS

(71) Applicant: Fraunhofer-Gesellschaft zur Förderung der Angewandten Forschung E.V., München (DE)

(72) Inventor: Armen HARUTYUNYAN, Dresden (DE)

(73) Assignee: Fraunhofer-Gesellschaft zur Förderung der Angewandten Forschung E.V., München (DE)

(21) Appl. No.: 17/596,387

(22) PCT Filed: Jun. 12, 2020
(86) PCT No.: PCT/EP2020/066337

§ 371 Date: Dec. 9, 2021

(30) Foreign Application Priority Data
Jun. 13, 2019 (DE) 10 2019 208 582.2

(51) Int. Cl. H02M 7/217; G06K 19/07

(52) U.S. Cl. CPC H02M 7/217; G06K 19/0723

(57) ABSTRACT

A rectifier cell for rectifying an electrical AC voltage, which rectifier cell comprises a transistor series circuit having a first field effect transistor and a second field effect transistor. A first frequency-independent voltage divider connected in parallel with the transistor series circuit has a first node which is connected to the gate electrode of the first field effect transistor. A second frequency-independent voltage divider connected in parallel with the transistor series circuit has a second node which is connected to the gate electrode of the second field effect transistor. In this case, the first and the second node of the frequency-independent voltage dividers are additionally each connected to earth via a bias capacitor.

The invention relates to a rectifier for rectifying an electrical AC voltage, particularly for AC voltage signals having a carrier frequency in the millimeter waveband.

The task of a rectifier is to convert an AC voltage into a DC voltage, for example, to ensure a supply of electrical energy to a passive transponder or electronic components located thereon. In RFID (radio-frequency identification) applications particularly, the AC voltage required therefor is often provided by electromagnetic waves emitted by a reader in the direction of an antenna located on the transponder. In this case, the electronic circuit of the rectifier is arranged between the antenna, which receives an AC voltage signal, and the electronic components of the transponder to be supplied with the DC voltage.

Using AC voltage signals having a carrier frequency in the millimeter waveband enables efficient on-chip integration of all components, including the antenna, and is therefore of great advantage for many mobile applications. Increased signal losses can have a disadvantageous effect in the millimeter waveband, for example, through increased free space attenuation, which is proportional to the square of the carrier frequency. For example, at the same distance, the loss of free space at a carrier frequency of 61 GHz is 37 dB higher than at a carrier frequency of 850 MHz. Dielectric losses also increase because they are directly proportional to the carrier frequency. Furthermore, the on-chip integration of the antenna increases the losses caused by parasitic excitation of surface modes of the substrate.

The AC voltage effectively applied to the input node of the rectifier also drops due to the strong signal losses. Transistors of the rectifier can then be pushed into a weak inversion or even sub-threshold range. Electronic circuits forming a rectifier known in the prior art have low efficiency under these conditions. The DC voltage generated may then not be large enough to supply the internal circuit of a transponder.

One option for increasing the efficiency of a rectifier is to effectively compensate for the threshold voltage of the transistors in order to convert the source-drain current into a moderate inversion range for a given input AC voltage. For example, patent EP 3 133 533 B1 proposes an auxiliary charge pump coupled to the electrodes of the transistors for the purpose of threshold voltage compensation. The auxiliary charge pump uses the power of the input signal to generate a switching voltage. However, this solution limits the power and the efficiency of the rectifier, since part of the input power is used to operate the auxiliary charge pump. Furthermore, the plurality of active and passive components with which the auxiliary charge pump is formed increases manufacturing costs and causes further signal losses.

The object of the invention is therefore to propose an electronic circuit for a rectifier cell which has a high degree of efficiency and can be produced cost-effectively.

According to the invention, the object is achieved by a rectifier cell having the features mentioned in claim 1. Advantageous variants result from the features mentioned in the subclaims.

The rectifier cell according to the invention for rectifying an electrical AC voltage comprises a transistor series connection having a first field effect transistor and a second field effect transistor, wherein a node arranged between the first and the second field effect transistor is connected via an input capacitor to an input node at which an electrical AC voltage can be applied.

A first frequency-independent voltage divider connected in parallel to the transistor series connection has a first node connected to the gate electrode of the first field effect transistor. A second frequency-independent voltage divider connected in parallel to the transistor series connection has a second node connected to the gate electrode of the second field effect transistor. The first and second nodes of the frequency-independent voltage dividers are each also connected to ground via a bias capacitor.

The field effect transistors of the transistor series connection are advantageously arranged in a cascaded manner with regard to their respective forward current direction. Cascading can be designed such that the drain electrode of the first field effect transistor is connected to the drain electrode of the second field effect transistor. The node of the transistor series connection connected to the input node via the input capacitor can be arranged between the drain electrode of the first field effect transistor and the drain electrode of the second field effect transistor.

The DC voltage present between the two source electrodes of the field effect transistors of the transistor series connection can then be used to supply an application, preferably to supply a load having a load resistance. For example, the source electrode of the first field effect transistor can be connected to ground, that is, to an electrical zero potential, via a first output node. The source electrode of the second field effect transistor can be connected to a load and/or a storage capacitor.

Due to the inventive construction of the rectifier cell, at least part of the original threshold voltage that would be present between the two source electrodes of the field effect transistors of the transistor series connection if no frequency-independent voltage dividers were connected or coupled in parallel to the transistor series connection can be used to compensate for the threshold voltage of the rectifier cell according to the invention. The threshold voltage can be almost completely compensated. In this way, the frequency-independent voltage dividers connected in parallel to the transistor series connection can effectively increase the input impedance and thus also the efficiency of the rectifier.

For example, a frequency-independent voltage divider can be formed with at least two bias resistors connected in series, which are designed as components. The bias resistors are particularly preferably designed as ohmic resistors. The bias resistors, which are designed as components, can be designed as noble metal layer resistors or as metal oxide layer resistors or as SMD (surface mounted device) components that can be arranged directly on a substrate. A frequency-independent voltage divider is particularly preferably not formed with any further components, apart from the electronic lines that connect components to one another. As a result, threshold voltage compensation is implemented with particularly simple means that are inexpensive to produce.

Such a passive threshold voltage compensation offers the special advantage of increasing the efficiency of the rectifier with respect to the solutions proposed in the prior art. Furthermore, the parasitic losses of the electronic circuit forming the rectifier cell are limited.

The optimal ratio of the ohmic resistances of the at least two series-connected bias resistors depends, among other things, on the load to be supplied having a load resistance, the input power of the AC voltage signal, the threshold voltage and the DC voltage to be achieved and can be determined by a numerical simulation of the electronic circuit.

When choosing the ratio of the ohmic resistances, it should be noted that the compensation of a threshold voltage can increase the efficiency of the rectifier cell, but it simultaneously also reduces the available DC voltage. Depending on the input power of the applied AC voltage signal available at the input node of the rectifier cell, the ohmic resistances of the bias resistors can be selected so that the DC achieved voltage of the rectifier cell is sufficient to supply a specified load and, simultaneously, the efficiency is higher than that of a rectifier cell that is formed with the transistor series connection without frequency-independent voltage dividers connected in parallel.

For example, the ratio of the ohmic resistances of the at least two series-connected bias resistors, which are designed as components of a frequency-independent voltage divider, can be selected so that the threshold voltage of a field effect transistor, whose gate electrode is connected to the node of the frequency-independent voltage divider, is almost completely compensated. The threshold voltage is almost completely compensated when it is less than 10% (compensation of the threshold voltage is 90%), preferably less than 5% (compensation of the threshold voltage is 95%), of the original threshold voltage.

At least one bias resistor of a frequency-independent voltage divider can have an ohmic resistance of at least 10 kOhm, preferably of at least 100 kOhm, to limit the current flowing through the frequency-independent voltage divider. All of the bias resistors of the rectifier cell can also have an ohmic resistance of at least 10 kOhm, preferably of at least 100 kOhm.

The bias capacitors are used to filter out high-frequency signal components and thereby contribute effectively to smoothing the DC voltage made available by the rectifier cell. For example, at least one bias capacitor can have a capacitance of at least 1 pF. All bias capacitors can also have a capacitance of at least 1 pF. It is particularly advantageous for the capacitances of the bias capacitors to be chosen so that the RC constants formed with the ohmic resistances of the bias resistors are large enough to filter out signal components whose frequency at least approximately corresponds to the carrier frequency of the AC voltage signal by means of the bias capacitors.

The rectifier cell can particularly be arranged on a substrate by means of integrated silicon-on-insulator (SOI) technology. The transistor series connection of the rectifier cell can be formed with an n-channel metal-oxide-semiconductor transistor (NMOS) and a p-channel metal-oxide-semiconductor transistor (PMOS), wherein the NMOS transistor and the PMOS transistor are arranged cascaded with respect to their respective forward current direction. For example, the first field effect transistor can be formed with an NMOS transistor and the second field effect transistor can be formed with a PMOS transistor. Cascading can then be designed such that the drain electrode of the NMOS transistor is connected to the drain electrode of the PMOS transistor via a node which is connected to the input node via the input capacitor. One advantage of SOI technology results from the lack of source-bulk and drain-bulk diodes that limit the signal losses caused by the substrate.

The input capacitor can advantageously be formed with a metal-oxide-metal capacitor (MOM). It is advisable to design the MOM capacitor particularly in different layers of a coating on the substrate and/or the substrate. For better shielding from the substrate, the MOM capacitor can be formed with an additional coating which can be arranged on a polysilicon layer and/or diffusion layer of the MOM capacitor. Such a construction of the input capacitor can limit signal losses caused by the substrate, for example, by parasitic capacitances.

In addition to the threshold voltage compensation by means of frequency-independent voltage dividers connected in parallel to the transistor series connection, the threshold voltage can also be modulated or compensated via the bulk connections of the field effect transistors with the aid of an auxiliary charge pump. A rectifier then comprises at least one rectifier cell and at least one auxiliary charge pump. For this purpose, the bulk connections of the field effect transistors are advantageously connected to the output nodes of the auxiliary charge pump. The auxiliary charge pump can also be formed by means of SOI technology.

A DC voltage of up to 2 V applied to the output node of the auxiliary charge pump can be achieved in the production of the rectifier cell and the auxiliary charge pump by means of integrated silicon-on-insulator (SOI) technology. This output voltage can then also contribute to the compensation of the threshold voltage via the bulk connections of the rectifier cell. The auxiliary charge pump can be coupled to an oscillator for periodic switching of the switches of the auxiliary charge pump. The oscillator can have a low switching frequency in the range from kHz to MHz. By combining both techniques for threshold voltage compensation, that is, resistive threshold voltage compensation by means of frequency-independent voltage dividers and dynamic threshold voltage compensation by means of an auxiliary charge pump, various design options (for example, layer thicknesses, dimensions, material compositions, geometries) of the respective circuit elements can be flexibly implemented or combined with one another, which can contribute to cost efficiency, an increase in efficiency and a compact design of the rectifier.

In order to be able to reliably provide a DC voltage over a long period of time for an application by means of the rectifier cell according to the invention, an electrode of a field effect transistor, preferably a source electrode of a field effect transistor, can be connected to a storage capacitor. The capacitance of the storage capacitor can be more than 5 nF. The settling time can be a few 100 microseconds, preferably less than 300 μs.

A plurality of rectifier cells can also be coupled to one another in an electronic circuit which forms a rectifier, wherein one rectifier cell forms one stage of the rectifier and the rectifier is formed from several stages. For example, two rectifier cells can be coupled so that a source electrode of a second field effect transistor of a first rectifier cell is connected to the source electrode of a first field effect transistor of a second rectifier cell. The source electrode of the first field effect transistor of the first rectifier cell can be connected to ground. The source electrode of the second field effect transistor of the second rectifier cell can be connected to a storage capacitor and/or to a load.

Further rectifier cells can also be arranged between the first and the second rectifier cell, wherein a source electrode of a second field effect transistor of the first or a further rectifier cell is connected to a source electrode of a first field effect transistor of a further or the second rectifier cell.

The rectifier formed with a plurality of rectifier cells can provide a DC voltage which results from the addition of the DC voltage generated by each rectifier cell. Only part of the input power of an AC voltage signal present at the input node is available to each rectifier cell.

The effective total impedance of a plurality of coupled rectifier cells is inversely proportional to the number of coupled rectifier cells for a given load resistance and a given input power. Depending on the area of application, the number of coupled rectifier cells for a given load and a given AC voltage signal thus also forms an optimization parameter. This optimization parameter can also be determined by a numerical simulation of the electronic circuit forming the rectifier.

The rectifier cell according to the invention can be used particularly in the field of RFID technology. The AC voltage signal can have a carrier frequency in the millimeter waveband, that is, between 30 GHz and 300 GHz. A carrier frequency can preferably be greater than 50 GHz. The carrier frequency is particularly preferably 60 GHz or 61 GHz. The rectifier cell according to the invention can also be used to rectify AC voltage signals having a carrier frequency that is less than 30 GHz.

For example, a rectifier formed with at least two coupled rectifier cells can be integrated in an RFID transponder to provide a rectified supply voltage for a load having a load resistance of at least 20 kOhm by means of rectifying an AC voltage signal that has a frequency of at least 50 GHz and an average power between −5 dBm and −1 dBm available at the input node. Alternatively, three or more rectifier cells can also be coupled to one another as stages of a rectifier. A load can also be formed by an effective load of a passive or active circuit, which circuit can comprise a plurality of electronic components.

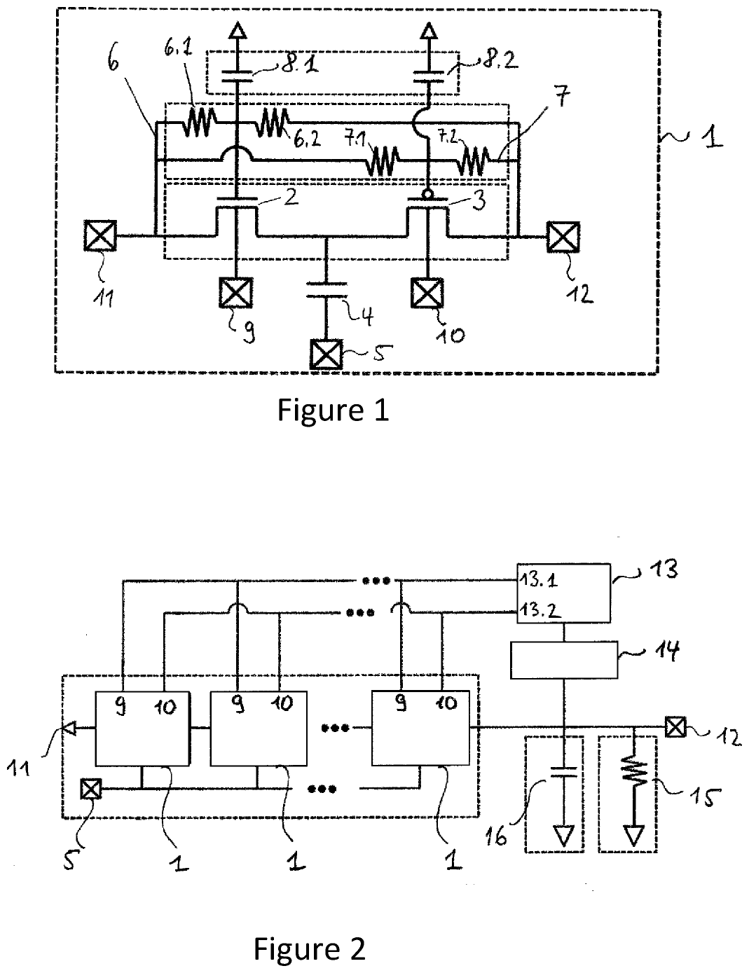

Exemplary embodiments of the invention are shown in the drawings and are explained in more detail below with reference to FIGS. 1 and 2.

Shown are

FIG. 1 a schematic illustration of an electronic circuit showing a rectifier cell according to the invention, and

FIG. 2 a schematic illustration of an electronic circuit showing a rectifier according to the invention formed with a plurality of rectifier cells.

FIG. 1 shows a rectifier cell 1 having a transistor series connection, which shows a first field effect transistor 2 designed as an NMOS transistor, which has a bulk connection 9, and a second field effect transistor 3 designed as a PMOS transistor, which has a bulk connection 10. The drain electrode of the first field effect transistor 2 is connected to the drain electrode of the second field effect transistor 3 via a node, wherein the node is connected to the input node 5 via an input capacitor 4 designed as a MOM capacitor. The NMOS transistor 2 and the PMOS transistor 3 form a transistor series connection cascaded in the forward direction.

Particularly, an AC voltage signal having a carrier frequency in the millimeter waveband that is greater than 50 GHz can be present at the input node 5.

The source electrode of the NMOS transistor 2 is connected to the source electrode of the PMOS transistor 3 via a first frequency-independent voltage divider 6 formed with two series-connected bias resistors 6.1, 6.2, and via a second frequency-independent voltage divider 7 also formed with two series-connected bias resistors 7.1, 7.2. Both the first and the second frequency-independent voltage dividers 6, 7 are arranged in parallel with the transistor series connection. The bias resistors 6.1, 6.2, 7.1, 7.2 are each designed as a component having an ohmic resistance of more than 10 kOhm.

A first node arranged between the two bias resistors 6.1, 6.2 of the first frequency-independent voltage divider 6 is connected to the gate electrode of the NMOS transistor 2 and connected to ground via a bias capacitor 8.1 having a capacitance of 1 pF. A second node arranged between the two bias resistors 7.1, 7.2 of the second frequency-independent voltage divider 7 is connected to the gate electrode of the PMOS transistor 3 and connected to ground via a bias capacitor 8.2 having a capacitance of 1 pF. The DC voltage present at the output nodes 11, 12 can be used as a supply voltage by an application, for example, by a load having a power resistor.

FIG. 2 shows a rectifier formed with a plurality of coupled rectifier cells 1, an auxiliary charge pump 13 with the output nodes 13.1, 13.2, an oscillator 14 and a storage capacitor 16. Recurring features are provided in this figure with the same reference numerals as in FIG. 1. The storage capacitor 16 has a capacitance of 6.2 nF. A load 15 can be connected to the source electrode of a PMOS transistor and/or to the output node 12. The rectifier cells 1 are connected to the input node 5 so that the input power of each rectifier cell 1 corresponds to at least part of the input power of an AC voltage signal present at the input node 5.

The rectifier cells 1 are coupled to one another such that a source electrode of the NMOS transistor 2 of a first rectifier cell 1 is connected to ground and a source electrode of the PMOS transistor 3 of a second rectifier cell 1 is connected to the storage capacitor 16. Further rectifier cells 1 can be arranged between the first and the second rectifier cell 1.

The bulk connections 9, 10 of the rectifier cells 1 are connected to the output nodes 13.1, 13.2 of the auxiliary charge pump 13. The oscillator 14 regulates the charge transfer of the auxiliary charge pump 13 by periodically switching over at least one switch of the auxiliary charge pump 13. The use of an auxiliary charge pump 13 regulated by an oscillator 14 also makes it possible to effectively compensate for the threshold voltage.

The number of coupled rectifier cells 1 can be selected as a function of the load resistance of the load 15 and the input power of the AC voltage signal applied to the input node 5. For example, the rectifier shown in FIG. 2 for an AC voltage signal having a carrier frequency of 61 GHz and an input power between −5 dBm and −1 dBm and a load resistance of 10 kOhm can be formed with two coupled rectifier cells 1. The efficiency of the rectifier can be greater than 2% and the DC voltage achieved can be more than 300 mV. With a load resistance of 50 kOhm, however, it is recommended to form a rectifier with three coupled rectifier cells 1. The efficiency of the rectifier can be greater than 0.7% and the DC voltage achieved can be more than 400 mV. With a load resistance of 1 kOhm and an input power of 5.2 dBm, the rectifier according to the invention can even achieve efficiencies of more than 6%.

1-10. (canceled)

11. A rectifier cell for rectifying an electrical AC voltage, comprising: a transistor series connection having a first field effect transistor and a second field effect transistor, a node arranged between the first and the second field effect transistor being connected via an input capacitor to an input node at which an electrical AC voltage can be applied,
a first frequency-independent voltage divider connected in parallel to the transistor series connection and having a first node connected to the gate electrode of the first field effect transistor,
a second frequency-independent voltage divider connected in parallel to the transistor series connection having a second node connected to the gate electrode of the second field effect transistor,
the first and the second node of the frequency-independent voltage dividers each also being connected to ground via at least one bias capacitor.

12. The rectifier cell according to claim 11, wherein at least one frequency-independent voltage divider is formed with at least two series-connected bias resistors which are designed as components.

13. The rectifier cell according to claim 12, wherein at least one of said at least two series-connected bias resistors of a frequency-independent voltage divider has an ohmic resistance of at least 10 kOhm for limiting the current flowing through the frequency-independent voltage divider.

14. The rectifier cell according to claim 11, wherein said at least one bias capacitor has a capacitance of at least 1 pF for filtering high-frequency signal components.

15. The rectifier cell according to claim 11, wherein the rectifier cell is manufactured in integrated silicon-on-insulator (SOI) technology and the transistor series connection is formed with an NMOS transistor as a first field effect transistor and a PMOS transistor as a second field effect transistor, wherein the NMOS transistor and the PMOS transistor are arranged in a cascading manner with respect to their respective forward current direction and the drain electrode of the NMOS transistor is connected to the drain electrode of the PMOS transistor.

16. The rectifier cell according to claim 11, wherein the source electrode of the first field effect transistor is connected to ground via a first output node and/or the source electrode of the second field effect transistor is connected to a load and/or a storage capacitor.

17. The rectifier cell according to claim 11, wherein the input capacitor is formed with a metal-oxide-metal capacitor (MOM).

18. A rectifier formed with at least one rectifier cell according to claim 11, wherein bulk connections of the field effect transistors of the at least one rectifier cell are connected to output nodes of an auxiliary charge pump coupled to an oscillator.

19. A rectifier formed with at least two coupled rectifier cells according to claim 11, wherein a source electrode of the second field effect transistor of a first rectifier cell is connected to a source electrode of the first field effect transistor of a second rectifier cell.

20. A use of a rectifier formed with at least two series-connected rectifier cells according to claim 11, which rectifier is integrated in an RFID transponder for providing a DC voltage for supplying a load having a load resistance of at least 20 kOhm by rectifying an AC voltage signal present at the input node having a carrier frequency of at least 50 GHz and an average power between −5 dBm and −1 dBm available at the input node.
